(19) United States
(12) Patent Application Publication
(10) Pub. No.: US 2023/0056600 A1
(43) Pub. Date: Feb. 23, 2023

(54) Gum Composition for Removing and Preventing Stains on Teeth

(71) Applicant: Rena Jhuty, Kent, WA (US)

(72) Inventor: Rena Jhuty, Kent, WA (US)

(21) Appl. No.: 17/880,194

(22) Filed: Aug. 3, 2022

Related U.S. Application Data
(60) Provisional application No. 63/232,263, filed on Aug. 12, 2021.

(51) Int. Cl. A23G 4/06; A23G 4/08

(52) U.S. Cl. CPC A23G 4/062; A23G 4/068; A23G 4/08

(57) ABSTRACT

A chewing gum composition effective in preventing the staining of teeth caused by the tannins in red wine and other staining agents in food. The chewing gum composition is also effective in removing the stains on teeth from consuming the staining food or drink. A coating agent is present in the composition in an effective amount to coat the teeth while chewing to generate a protective film on the tooth enamel thereby preventing staining. A tannin or stain removing agent is present in the composition in an effective amount to remove stains from tooth enamel. The chewing gum composition is usable before consumption of the staining food or drink to prevent staining or after the consumption of the staining food or drink to remove stains.

### CROSS-REFERENCE TO RELATED APPLICATION

The present application claims priority to, and the benefit of, U.S. Provisional Application No. 63/232,263, which was filed on Aug. 12, 2021 and is incorporated herein by reference in its entirety.

### FIELD OF THE INVENTION

The present invention generally relates to oral hygiene, and more specifically to a chewing gum configured to prevent and remove staining from red wine and other staining foods and beverages. Accordingly, the present specification makes specific reference thereto. However, it is to be appreciated that aspects of the present invention are also equally amenable to other like applications, devices, and methods of manufacture.

### BACKGROUND

Individuals often enjoy a glass of red wine while out to dinner with friends or while on a date. Unfortunately, red wine is notorious for staining the teeth and gums. This staining is often unavoidable and embarrassing. Other food and drink items, such as colored frosting, coffee, and candy, can cause stains as well. Currently, there is no effective means for preventing the stains from occurring prior to consuming wine. There is also not a discreet means for removing the wine stains from teeth once they occur.

Teeth are inherently protected by an enamel layer that is naturally white or off white in color. This enamel layer becomes stained or discolored and can turn a soft purple color after drinking red wine. Over time, red wine and coffee can cause teeth to become more brown, blue, dingy gray, or purple. The discoloration occurs because red wine contains acids, tannin, and natural dyes, all of which can leave the teeth etched and stained. This discoloration is generally undesirable as it not cosmetic and can indicate poor oral hygiene.

Teeth encounter several threats when exposed to red wine. There are anthocyanin pigments in grapes that give red wine its purplish color. There are also tannins found in the skins, seeds, and stems that can bind the colored pigment to teeth. Finally, the natural acidity found in wine makes tooth enamel more porous causing the wine stain to stick to the teeth. It is essential to maintain proper enamel care and prevent plaque buildup on teeth so that wine pigments have a more difficult time sticking to teeth.

While eating, absorbent food particles can cling to teeth creating another staining hazard. The food particles can take on the color of the wine when drinking wine while eating further exacerbating enamel staining. Brushing teeth after eating and before drinking red wine can help prevent this problem. Flossing teeth after eating and before drinking red wine can also help by removing food particles stuck between the teeth. Another preventative option is to drink red wine from a straw so that the wine bypasses the teeth. Unfortunately, red wine isn't commonly consumed with a straw.

Another preventative option is to chew sugarless gum to remove food particles stuck to teeth before drinking red wine. Drinking carbonated or sparkling water can help wash or dilute wine and prevent your teeth from becoming stained. Unfortunately, this requires the individual to alternate sips of wine with sips of water. Teeth wipes are cloths that can help wipe away food and red wine stains while drinking wine. There are also many tooth-whitening products available for post wine consumption. Some of these products are minimally effective, while others damage teeth by stripping away the enamel, leaving teeth more sensitive and vulnerable to stains.

Even consuming white wine does not protect teeth from stains and discolorations. While white wine won't discolor teeth like red wine, its high acidity can still contribute to tooth staining. White wine erodes enamel and increases the number of holes and pores in teeth making teeth more vulnerable to other stains. Another common preventative option is sucking on a lime or by brushing teeth with lemon juice and baking soda. Unfortunately, limes and lemons both have a high acid content that can damage teeth in the same way that white wine can damage teeth. In addition, baking soda is abrasive and can scratch away tooth enamel leaving teeth more vulnerable to future staining.

Accordingly, there is a great need for a way to prevent tooth staining before drinking red wine. There is also a need for a way for a way to prevent tooth staining before consuming other beverages or foods with coloring agents. Similarly, there is a need for a way to coat teeth with a protective layer. There is also a need for a way to remove stains left behind by wine or foods and beverages. Further, there is a need for a compound that allows users to discreetly eliminate stains from teeth.

In this manner, the improved oral care composition of the present invention accomplishes all of the forgoing objectives, thereby providing an easy solution for preventing tooth staining before drinking red wine. A primary feature of the present invention is a gum composition configured for use before consuming red wine or other beverages or foods with heavy coloring agents. The present invention assists individuals in preventing stains by coating the teeth with a film before consuming a staining agent. Finally, the improved stain preventing and removing composition of the present invention is capable of removes stains left behind after consuming red wine or other staining foods and beverages.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a gum composition. The gum composition is effective in preventing discoloration of tooth enamel caused by ingesting food or drink. The gum composition is formulated to protect the teeth with a protective layer prior to consuming the staining food or drink.

The gum composition comprises a gum base, at least one shaping agent, at least one sweetening agent, at least one flavoring agent, and at least one texturizing agent. The gum base comprises a combination of a maltitol syrup, a mannitol crystal, a palm oil, and an emulsifier. The at least one shaping agent is a solid polyvinyl acetate resin. The at least one sweetening agent may be citric acid, malic acid, acesulfame-K, sucralose, or a combination thereof. The at least one flavoring agent may be a coconut flavoring, a citrus flavoring, a mint flavoring, or a combination there of.

The gum composition further comprises a coating agent. The coating agent is configured to coat the tooth enamel with a protective film layer. The protective film is released from the gum composition during mastication. The coating agent may be a coconut oil.

In an additional embodiment, the subject matter disclosed and claimed herein comprises a gum composition. The gum composition is effective in removing discoloration of tooth enamel from stains caused by ingesting food or drink. The gum composition is formulated to remove the stains from tooth enamel after consuming the staining food or drink.

The gum composition comprises a gum base, at least one shaping agent, at least one sweetening agent, at least one flavoring agent, and at least one texturizing agent. The gum base comprises a combination of a maltitol syrup, a mannitol crystal, a palm oil, and an emulsifier. The at least one shaping agent is a solid polyvinyl acetate resin. The at least one sweetening agent may be citric acid, malic acid, acesulfame-K, sucralose, or a combination thereof. The at least one flavoring agent may be a coconut flavoring, a citrus flavoring, a mint flavoring, or a combination there of.

The gum composition further comprises a stain removing agent. The stain removing agent is formulated to remove tannins from tooth enamel. The stain removing agent is released from the gum composition during mastication. The stain removing agent may be an effective amount of a food grade polyvinylpyrrolidone powder (PVP-P).

In an additional embodiment, the subject matter disclosed and claimed herein comprises a gum composition. The gum composition is effective in preventing discoloration of tooth enamel caused by ingesting food or drink. The gum composition is formulated to protect the teeth with a protective layer prior to consuming the staining food or drink. The gum composition is also effective in removing discoloration of tooth enamel from stains caused by ingesting food or drink. The gum composition is further formulated to remove the stains from tooth enamel after consuming the staining food or drink.

The gum composition comprises a gum base, at least one shaping agent, at least one sweetening agent, at least one flavoring agent, and at least one texturizing agent. The gum base comprises a combination of a maltitol syrup, a mannitol crystal, a palm oil, and an emulsifier. The at least one shaping agent is a solid polyvinyl acetate resin. The at least one sweetening agent may be citric acid, malic acid, acesulfame-K, sucralose, or a combination thereof. The at least one flavoring agent may be a coconut flavoring, a citrus flavoring, a mint flavoring, or a combination there of.

The gum composition further comprises a coating agent. The coating agent is configured to coat the tooth enamel with a protective film layer. The protective film is released from the gum composition during mastication. The coating agent may be a coconut oil.

The gum composition further comprises a stain removing agent. The stain removing agent is formulated to remove tannins from tooth enamel. The stain removing agent is released from the gum composition during mastication. The stain removing agent may be an effective amount of a food grade polyvinylpyrrolidone powder (PVP-P).

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The improved oral care composition is a solution for decreasing or preventing tooth staining prior to the consumption of red wine or other staining food and drink. A gum composition is designed for use before consuming beverages or foods with heavy coloring agents or tannins. The gum composition is configured to coat the teeth with a film before consuming a staining agent. The improved stain preventing and removing composition is also capable of removes stains left behind after consuming red wine or other staining foods and beverages.

The improved oral care composition is a wine stain prevention organic chewing gum designed to prevent stains to the teeth caused by wine or other coloring agents present in foods and beverages. The gum can also be used after wine consumption for removing the stains. The invention is comprised of an organic natural coconut chewing gum. The coconut oil coats the teeth with a film preventing the wine tannins from penetrating the tooth surface enough to stain it. Chewing the gum after the wine is consumed will pull the stains form the teeth through the act of chewing the gum. The gum may be discreetly stored in a small compact case for use anywhere.

The present invention, in one exemplary embodiment, is a gum composition. The gum composition is effective in preventing discoloration of tooth enamel caused by ingesting food or drink with a staining agent. The staining agent may be tannins present in red wine, or any other coloring or dying agent that may be present foods or beverages, such as coffee, icing, or the like. The gum composition is formulated to protect the teeth by forming a protective layer on tooth enamel prior to consuming the staining food or drink. The chewing gum composition is usable before consumption of the staining food or drink to prevent staining or after the consumption of the staining food or drink to remove stains.

The gum composition comprises a gum base, at least one shaping agent, at least one sweetening agent, at least one flavoring agent, and at least one texturizing agent. The gum base comprises a combination of a maltitol syrup, a mannitol crystal, a palm oil, and an emulsifier. The gum base may be present in the gum composition in a range of up to 80% by weight of the gum composition. In one formulation, a quantity of the maltitol syrup present in the composition is in a range of 40-50% by weight, and a quantity of the mannitol crystal present is in the composition in a range of 15-20% by weight.

The at least one shaping agent may be present in the gum composition in a range of up to 25% by weight of the gum composition. The at least one shaping agent may be a solid polyvinyl acetate resin, such as, but not limited to CAPIVA® C 03. In one formulation, a quantity of the CAPIVA® C 03 present in the composition is in a range of 15-25% by weight.

The at least one sweetening agent may be citric acid, malic acid, acesulfame-K, sucralose, or a combination thereof. In one formulation, a quantity of the at least one sweetening agent present in the composition is in a range of 1-2% by weight. The at least one flavoring agent may be a coconut flavoring, a citrus flavoring, a mint flavoring, or a combination there of. In one formulation, a quantity of the at least one flavoring agent present in the composition is in a range of 1-2% by weight.

The gum composition further comprises a coating agent. The coating agent is configured to coat the tooth enamel with a protective film layer. The protective film is released from the gum composition during chewing to coat the teeth. The coating agent may be a coconut oil. The coating agent is present in the gum composition in an effective amount to coat the teeth while chewing to generate a protective film on the tooth enamel thereby preventing staining. The gum composition may further comprises at least one moisturizing agent, such as, but not limited to glycerol, lecithin, or water.

In an additional embodiment, the subject matter disclosed and claimed herein comprises a gum composition. The gum composition is effective in removing discoloration from staining of tooth enamel caused by ingesting food or drink. The staining agent may be tannins present in red wine, or any other coloring or dying agent that may be present foods or beverages, such as coffee, icing, or the like. The gum composition is formulated to remove the stains from tooth enamel after consuming the staining food or drink.

The gum composition comprises a gum base, at least one shaping agent, at least one sweetening agent, at least one flavoring agent, and at least one texturizing agent. The gum base comprises a combination of a maltitol syrup, a mannitol crystal, a palm oil, and an emulsifier. The gum base may be present in the gum composition in a range of up to 80% by weight of the gum composition. In one formulation , a quantity of the maltitol syrup present in the composition is in a range of 40-50% by weight, and a quantity of the mannitol crystal present is in the composition in a range of 15-20% by weight.

The at least one shaping agent may be present in the gum composition in a range of up to 25% by weight of the gum composition. The at least one shaping agent may be a solid polyvinyl acetate resin, such as, but not limited to CAPIVA® C 03. In one formulation, a quantity of the CAPIVA® C 03 present in the composition is in a range of 15-25% by weight.

The at least one sweetening agent may be citric acid, malic acid, acesulfame-K, sucralose, or a combination thereof. In one formulation, a quantity of the at least one sweetening agent present in the composition is in a range of 1-2% by weight. The at least one flavoring agent may be a coconut flavoring, a citrus flavoring, a mint flavoring, or a combination there of In one formulation, a quantity of the at least one flavoring agent present in the composition is in a range of 1-2% by weight.

The gum composition further comprises a stain removing agent. The stain removing agent is formulated to remove tannins or other stains caused by consuming food or drink from tooth enamel. The stain removing agent is released from the gum composition during mastication. The stain removing agent may be a tannin removing agent. The stain removing agent may be an effective amount of a food grade polyvinylpyrrolidone powder (PVP-P). The tannin or stain removing agent is present in the composition in an effective amount to remove stains from tooth enamel. PVP-P is hygroscopic and insoluble in water. It is particularly effective at removing polyphenols and tannin substances from beverages. In one formulation, a quantity of the PVP-P present in the composition is in a range of 0.4-0.8% by weight. The gum composition may further comprises at least one moisturizing agent, such as, but not limited to glycerol, lecithin, or water.

In an additional embodiment, the subject matter disclosed and claimed herein comprises a gum composition. The gum composition is effective in preventing discoloration of tooth enamel caused by ingesting food or drink. The gum composition is formulated to protect the teeth with a protective layer prior to consuming the staining food or drink. The gum composition is also effective in removing discoloration of tooth enamel from stains caused by ingesting food or drink. The gum composition is further formulated to remove the stains from tooth enamel after consuming the staining food or drink. The staining agent may be tannins present in red wine, or any other coloring or dying agent that may be present foods or beverages, such as coffee, icing, or the like.

The gum composition comprises a gum base, at least one shaping agent, at least one sweetening agent, at least one flavoring agent, and at least one texturizing agent. The gum base comprises a combination of a maltitol syrup, a mannitol crystal, a palm oil, and an emulsifier. The gum base may be present in the gum composition in a range of up to 80% by weight of the gum composition. In one formulation , a quantity of the maltitol syrup present in the composition is in a range of 40-50% by weight, and a quantity of the mannitol crystal present is in the composition in a range of 15-20% by weight.

The at least one shaping agent may be present in the gum composition in a range of up to 25% by weight of the gum composition. The at least one shaping agent may be a solid polyvinyl acetate resin, such as, but not limited to CAPIVA® C 03. In one formulation, a quantity of the CAPIVA® C 03 present in the composition is in a range of 15-25% by weight.

The at least one sweetening agent may be citric acid, malic acid, acesulfame-K, sucralose, or a combination thereof. In one formulation, a quantity of the at least one sweetening agent present in the composition is in a range of 1-2% by weight. The at least one flavoring agent may be a coconut flavoring, a citrus flavoring, a mint flavoring, or a combination there of In one formulation, a quantity of the at least one flavoring agent present in the composition is in a range of 1-2% by weight.

The gum composition further comprises a coating agent. The coating agent is configured to coat the tooth enamel with a protective film layer. The protective film is released from the gum composition during mastication to coat the teeth. The coating agent may be a coconut oil. The coating agent is present in the gum composition in an effective amount to coat the teeth while chewing to generate a protective film on the tooth enamel thereby preventing staining. The gum composition may further comprises at least one moisturizing agent, such as, but not limited to glycerol, lecithin, or water.

The gum composition further comprises a stain removing agent. The stain removing agent is formulated to remove tannins or other stains caused by consuming food or drink from tooth enamel. The stain removing agent is released from the gum composition during mastication. The stain removing agent may be a tannin removing agent. The stain removing agent may be an effective amount of a food grade polyvinylpyrrolidone powder (PVP-P). The tannin or stain removing agent is present in the composition in an effective amount to remove stains from tooth enamel. PVP-P is hygroscopic and insoluble in water. It is particularly effective at removing polyphenols and tannin substances from beverages. In one formulation, a quantity of the PVP-P present in the composition is in a range of 0.5-0.6% by weight.

In a preferred formulation, the gum composition formulation is comprised of Maltitol syrup (Cargill Maltidex M16311) at approximately 42.0% by weight. Maltitol syrup is advantageous as it is a high-quality sugar alternative. Maltidex® maltitol is a polyol derived from the hydrogenation of sugars, from corn or wheat starch, and offers an easy one-to-one sucrose or full-calorie sweetener substitution while reducing calories. It has a clean, pleasant taste and offers good humidity and moisture control, which stabilizes products, and improves texture and mouthfeel. Maltidex® has an energy value of 2.4 kcal/g, compared to full-calorie sweeteners at 4 kcal/g for sugar reduction. It also offers similar sweetness to sucrose with a natural, sweet taste and boost fruity flavors, and reduces the need for high-intensity sweeteners. Finally, it is non-cariogenic and does not contribute to tooth decay.

The gum composition formulation is further comprised of Mannitol cryst. (Roquette Mannitol 60) at approximately 0.19% by weight. Mannitol cryst. Is a sugar-free, low hygroscopic bulk sweetener providing stability to confectionary products such as chewing gum. Thanks to its inert properties. Mannitol is used as a dusting agent in sugar-free chewing gums while also allowing adjustment of texture in gums and chewy sweets.

The gum composition formulation is further comprised of coconut oil at approximately 0.05% by weight. The coconut oil is used as a palm oil replacement as an emulsifier and enamel coating. The gum composition formulation is further comprised of Emulsifier (Grindsted® ACETEM 50-00P) at approximately 0.80% by weight. GRINDSTED® ACETEM Acetic Acid Ester is an emulsifier for aeration, foam stability and film-formation. Benefits include aeration & foam stabilizing, film-forming capability, efficient plasticizer, and improved product quality. The gum composition formulation is further comprised of glycerol at approximately 0.02% by weight to keep oils in suspension in water; lecthin at approximately 0.5% by weight as a natural emulsifier and stabilizer; and water at approximately 4.4% by weight.

The gum composition formulation is further comprised of CAPIVA® C 03 (pre-melted at 120° C.) at approximately 0.6% by weight. Wacker Chemical's Capiva C 03 CANDY2GUM products are simply boiled. Conventional chewing gum, on the other hand, is made in a dry kneading process. Water based and fat-containing ingredients, such as fruit juice and cocoa, are exactly what the traditional kneading process cannot handle. The premix is just added to the candy mass and a simple piece of chewy candy becomes a unique product.

The gum composition formulation is further comprised of citric acid at approximately 19.6% by weight. Citric acid increases the acidity in the mouth providing a sharp refreshing citrus taste. The gum composition formulation is further comprised of malic acid at approximately 0.3% by weight. Malic acid is generated during fruit metabolism and occurs naturally in all fruits and many vegetables. It intensifies the impact of many flavors in foods or beverages, often reducing the amount of flavor needed. Malic Acid is formed in metabolic cycles in the cells of plants and animals, including humans. The compound provides cells with energy and carbon skeletons for the formation of amino acids. Benefits include blending distinct flavors resulting in a well-rounded flavor experience, improving aftertaste by extending the impact of some flavors, increasing burst and aromaticity of some flavor notes in certain beverage application, and deepening and broadening the flavor profile of many products resulting in a richer, more natural flavor experience.

The gum composition formulation is further comprised of acesulfame-K at approximately 0.1% by weight. Acesulfame potassium (Ace-K) is a zero-calorie, tooth-friendly sweetener that is 200 times sweeter than sugar. It is an extremely versatile, synergistic sweetener that helps customers achieve unique taste profiles. The gum composition formulation is further comprised of Miswak powder at approximately 7.0% by weight. The use of miswak for oral hygiene serves a dual function, mechanical control of enamel attractive elements by friction between plant fibers and tooth surface and chemical control due to its binding releasing composition.

The gum composition formulation is further comprised of powdered or shredded natural coconut at approximately 12.0% by weight as a flavoring and mechanical gradient during chewing to remove compounds; Quercetin Dihydrate (Sophora Japonica) in trace amounts as a periodontal anti-inflammatory to stabilize the oral micro-biome; and Patatin from potato tubers at approximately 11.9% by weight to bind wine phenolic compounds acting as carrier of released compounds. Finally, the gum composition formulation is further comprised of Mannitol cryst. (Roquette Mannitol 60-Food Grade PVP-P) at approximately 0.5% by weight acting as a low hygroscopicity sugar-free bulk sweetener that adds stability.

The steps to formulate this gum composition formulation are as follows. The maltitol syrup, the mannitol cryst. (Roquette Mannitol 60), the coconut oil, the emulsifier, the glycerol, the lecthin, and the water are homogenized and cooked to approximately between 128-135° Celsius while stirring continuously at a medium speed. The target moisture content of the final product is 6-7.5%. Then the mass is transferred to a mixer for further incorporation. Then the CAPIVA® is added and continue stirring at maximum speed is initiated and continued until a homogeneous mixture is reached.

Next, the citric acid, malic acid, and Acesulfam-K is added at a temperature range of approximately between 110-100° Celsius and mixing continues. Then the Miswick powder, the natural coconut, the quercetin dihydrate, and the patatin is added at a temperature range of approximately between 100-90° Celsius and mixing continues. Next, the Mannitol cryst. (Roquette Mannitol 60-Food Grade PVP-P) is added at a temperature range of approximately between 80-70° Celsius and mixing continues. Finally, the mixture is cooled on a cooling table to approximately between 35-45° Celsius and run through a batch roller/rope sizer or extruder, followed by cut and wrap.

The following are additional nonlimiting examples provided to further illustrate formulations of the present invention.

### EXAMPLES

### Formulation 1

A gum composition formulation for preventing tooth discoloration from staining is prepared with the following ingredients and amounts:

| | | | Calculated on |
|---|---|---|---|
| | | Parts by weight | dry substance |
| | | before cooking | of final product |
| Ingredient | | (kg) | (%) |
| (A) | Maltitol syrup (Cargill Maltidex M16311) | 48.9 | 44.2 |
| | Mannitol cryst. (Roquette Mannitol 60) | 15.7 | 19.0 |
| | Palm oil (Henry Lamotte Refined RSPO) | 5.0 | 5.3 |
| | Emulsifier (Grindsted ® ACETEM 50-00P) | 0.7 | 0.8 |
| | Glycerol | 2.4 | 2.9 |
| | Lecithin | 0.4 | 0.5 |
| | Water | 4.4 | |
| (B) | CAPIVA ® C03 (pre-melted at 120° C.) | 19.6 | 23.07 |
| (C) | Citric Acid | 0.6 | 0.7 |
| | Malic Acid | 0.5 | 0.6 |
| | Acesulfam -K | 0.1 | 0.1 |
| | Sucralose | 0.03 | 0.04 |
| (D) | Flavor (Symrise Lemon #220496) | 1.0 | 1.2 |
| | Flavor (Symrise Optimint #201588) | 0.13 | 0.2 |
| (E) | Mannitol cryst. (Roquette Mannitol 60) | 0.5 | 0.6 |

This formulation represents one potential embodiment of a typical combination of ingredients of a gum composition formulation. To combine, homogenize the (A) ingredients and cook while stirring until the moisture content is between approximately 6-7.5%. Then add ingredient (B) and stir to create a homogeneous mixture. Next, add ingredients (C), (D), and (E) separately at gradually decreasing temperatures while continually mixing. The final gum composition is then cooled to room temperature.

### Formulation 2

A gum composition formulation for removing tooth discoloration from staining is prepared with the following ingredients and amounts:

| | | | Calculated on |
|---|---|---|---|
| | | Parts by weight | dry substance |
| | | before cooking | of final product |
| Ingredient | | (kg) | (%) |
| (A) | Maltitol syrup (Cargill Maltidex M16311) | 48.9 | 44.2 |
| | Mannitol cryst. (Roquette Mannitol 60) | 15.7 | 19.0 |
| | Palm oil (Henry Lamotte Refined RSPO) | 5.0 | 5.3 |
| | Emulsifier (Grindsted ® ACETEM 50-00P) | 0.7 | 0.8 |
| | Glycerol | 2.4 | 2.9 |
| | Lecithin | 0.4 | 0.5 |
| | Water | 4.4 | |
| (B) | CAPIVA ® C03 (pre-melted at 120° C.) | 19.6 | 23.07 |
| (C) | Citric Acid | 0.6 | 0.7 |
| | Malic Acid | 0.5 | 0.6 |
| | Acesulfam -K | 0.1 | 0.1 |
| | Sucralose | 0.03 | 0.04 |
| (D) | Flavor (Symrise Lemon #220496) | 1.0 | 1.2 |
| | Flavor (Symrise Optimint #201588) | 0.13 | 0.2 |
| (E) | Mannitol cryst. (Roquette Mannitol 60) | 0.5 | 0.6 |
| | Food grade PVP-P (Jiaozuo Zhongwei) | 0.5 | 0.6 |

This formulation represents one potential embodiment of a typical combination of ingredients of a gum composition formulation. To combine, homogenize the (A) ingredients and cook while stirring until the moisture content is between approximately 6-7.5%. Then add ingredient (B) and stir to create a homogeneous mixture. Next, add ingredients (C), (D), and (E) separately at gradually decreasing temperatures while continually mixing. The final gum composition is then cooled to room temperature.

### Formulation 3

A gum composition formulation for preventing tooth discoloration and removing tooth discoloration from staining is prepared with the following ingredients and amounts:

| | | | Calculated on |
|---|---|---|---|
| | | Parts by weight | dry substance |
| | | before cooking | of final product |
| Ingredient | | (kg) | (%) |
| (A) | Maltitol syrup (Cargill Maltidex M16311) | 48.9 | 44.2 |
| | Mannitol cryst. (Roquette Mannitol 60) | 15.7 | 19.0 |
| | Palm oil (Henry Lamotte Refined RSPO) | 5.0 | 5.3 |
| | Emulsifier (Grindsted ® ACETEM 50-00P) | 0.7 | 0.8 |
| | Glycerol | 2.4 | 2.9 |
| | Lecithin | 0.4 | 0.5 |
| | Water | 4.4 | |
| (B) | CAPIVA ® C03 (pre-melted at 120° C.) | 19.6 | 23.07 |
| (C) | Citric Acid | 0.6 | 0.7 |
| | Malic Acid | 0.5 | 0.6 |
| | Acesulfam -K | 0.1 | 0.1 |
| | Sucralose | 0.03 | 0.04 |
| (D) | Flavor (Symrise Lemon #220496) | 1.0 | 1.2 |
| | Flavor (Symrise Optimint #201588) | 0.13 | 0.2 |
| (E) | Mannitol cryst. (Roquette Mannitol 60) | 0.5 | 0.6 |
| | Food grade PVP-P (Jiaozuo Zhongwei) | 0.5 | 0.6 |

This formulation represents one potential embodiment of a typical combination of ingredients of a gum composition formulation. To combine, homogenize the (A) ingredients and cook while stirring until the moisture content is between approximately 6-7.5%. Then add ingredient (B) and stir to create a homogeneous mixture. Next, add ingredients (C), (D), and (E) separately at gradually decreasing temperatures while continually mixing. The final gum composition is then cooled to room temperature.

Notwithstanding the forgoing, the gum composition can be any suitable size, shape, and configuration as is known in the art without affecting the overall concept of the invention, provided that it accomplishes the above stated objectives. One of ordinary skill in the art will appreciate that the shape and size of the gum composition and its various components, are for illustrative purposes only, and that many other shapes and sizes of the gum composition are well within the scope of the present disclosure. Although dimensions of the gum composition and its components (i.e., length, width, and height) are important design parameters for good performance, the gum composition and its various components may be any shape or size that ensures optimal performance during use and/or that suits user need and/or preference. As such, the gum composition may be comprised of sizing/shaping that is appropriate and specific in regard to whatever the gum composition is designed to be applied.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A gum composition for preventing discoloration of teeth comprising:
a gum base;
at least one shaping agent;
at least one sweetening agent;
at least one flavoring agent;
at least one texturizing agent; and
a coating agent.

2. The gum composition of claim 1, wherein the gum base comprises a maltitol syrup, a mannitol crystal, a palm oil, and an emulsifier, and wherein a quantity of the maltitol syrup present in the composition in a range of 40-50% by weight, and wherein a quantity of the mannitol crystal present in the composition in a range of 15-20% by weight.

3. The gum composition of claim 1, wherein the at least one shaping agent is a solid polyvinyl acetate resin, and wherein a quantity of the solid polyvinyl acetate resin present in the composition in a range of 15-25% by weight.

4. The gum composition of claim 1, wherein the at least at least one sweetening agent is citric acid, malic acid, acesulfame-K, or sucralose.

5. The gum composition of claim 1, wherein the least one flavoring agent is a coconut flavoring.

6. The gum composition of claim 1, wherein the coating agent is coconut oil.

7. The gum composition of claim 1, wherein the coating agent is configured to coat the teeth with a protective film while chewing the gum composition.

8. A gum composition for removing discoloration from teeth comprising;
a gum base;
at least one shaping agent;
at least one sweetening agent;
at least one flavoring agent;
at least one texturizing agent; and
a stain removing agent.

9. The gum composition of claim 8, wherein the gum base comprises a maltitol syrup, a mannitol crystal, a palm oil, and an emulsifier, and wherein a quantity of the maltitol syrup present in the composition in a range of 40-50% by weight, and wherein a quantity of the mannitol crystal present in the composition in a range of 15-20% by weight.

10. The gum composition of claim 8, wherein the at least one shaping agent is a solid polyvinyl acetate resin, and wherein a quantity of the solid polyvinyl acetate resin present in the composition in a range of 15-25% by weight.

11. The gum composition of claim 8, wherein the at least at least one sweetening agent is a combination of citric acid, malic acid, acesulfame-K, and sucralose.

12. The gum composition of claim 8, wherein the least one flavoring agent is a coconut flavoring.

13. The gum composition of claim 8, wherein the stain removing agent is a tannin removing agent.

14. The gum composition of claim 8, wherein the stain removing agent is a food grade polyvinylpyrrolidone powder (PVP-P),

15. The gum composition of claim 14, wherein a quantity of the polyvinylpyrrolidone powder present in the composition in a range of 0.4-0.8% by weight.

16. A gum composition for preventing discoloration of teeth and removing discoloration from teeth comprising:
a gum base;
at least one shaping agent;
at least one sweetening agent;
at least one flavoring agent;
at least one texturizing agent;
a coating agent; and
a stain removing agent.

17. The gum composition of claim 16 further comprising at least one moisturizing agent.

18. The gum composition of claim 17, wherein the coating agent is coconut oil configured to coat the teeth with a protective film while chewing the gum composition.

19. The gum composition of claim 18, wherein the stain removing agent is a tannin removing agent, and wherein a quantity of the tannin removing agent present in the composition in a range of 0.5-0.6% by weight.

20. The gum composition of claim 19, wherein the tannin removing agent is a food grade polyvinylpyrrolidone powder (PVP-P).
